(19) United States
(12) Patent Application Publication
(10) Pub. No.: US 2008/0256824 A1
(43) Pub. Date: Oct. 23, 2008

(54) Method of Treating a Piece of Wood at an Elevated Temperature

(75) Inventors: Pertti Viitaniemi, Helsinki (FI); Saila Jamsa, Espoo (FI); Pentri Ek, Espoo (FI)

Correspondence Address: SUGHRUE MION, PLLC, 2100 PENNSYLVANIA AVENUE, N.W., SUITE 800, WASHINGTON, DC, 20037, US

(73) Assignee: Valtion Teknillinen Tutkimuskeskus, Espoo (FI)

(21) Appl. No.: 11/884,773

(22) PCT Filed: Feb. 22, 2006
(86) PCT No.: PCT/FI2006/000061

§ 371 Date: Nov. 8, 2007

(30) Foreign Application Priority Data
Feb. 22, 2005 (FI) 20050208

(51) Int. Cl. F26B 3/00

(52) U.S. Cl. 34/476

(57) ABSTRACT

The present invention relates to a method of heat treatment of a solid piece of wood, such as sawn timber. According to the method, the temperature difference between the inside temperature of the heating oven and, correspondingly, the inside temperature of the wood is maintained at a maximum of 10° C., after the level of moisture content of the piece of wood has reached the fibre saturation point of the wood. A small temperature difference such as this is maintained when the temperature is further increased until a level of moisture content is reached at which the strength properties of the piece of wood are at their best. By means of the solution it is possible to considerably reduce the formation of internal cracks in heat treated wood.

The present invention relates to a method according to the preamble of claim 1 of treating a piece of wood, which comprises solid wood, at an elevated temperature.

According to a method of such a method, a piece of wood, the moisture content of which is at least 25%, typically at least 30%, is placed in an oven in which it is heated until the inside temperature of the piece of wood has increased to a pre-selected temperature. The heating is carried out in the presence of water steam.

It is well known that heat treatment can be used to improve the dimensional stability of wood. As regards known technology, reference can be made for instance to FI Patent Specification No. 68122, which describes a method of treating timber at a temperature of 160-240° C. and a pressure of 3-15 bar, in which case the ability of the wood to absorb water and thus to swell were considerably decreased.

Other heat treatment methods have been described in U.S. Patent Specification No. 1 366 225, in DE Published Patent Application No. 2 263 758, and in an article by Stamm, A. J. and Baechler, R. H. titled “Decay Resistance and Dimensional Stability of Five Modified Woods”, Forest Products Journal, January 1960.

None of these solutions is suitable for industrial use. Consequently, the methods described in FI Patent Specification No. 68122 and DE Published Patent Application No. 2 263 758 require the use of an autoclave. In FI Patent Specification No. 68122 it is pointed out, with reference to U.S. Patent Specification No. 1 366 255, that the old solution in question does not offer any means of stabilizing the wood. There is no reference to any industrially functional method in the publication by Stamm, either; in the experimental arrangement they used, small pieces of wood are heated between two hot bronze plates, which may lead to the wood catching fire.

In fact, the first industrially applicable method is presented in our earlier FI Patent Specification No. 104285, which describes a two-stage method for improving the resistance to biodegradation and the dimensional stability of wood. In this method, the wood is first dried to a moisture content of less than 15%, whereafter it is heat treated at 180-250° C., in which case the heat treatment is carried out at normal air pressure in a moist oven into which steam is fed, and the heat treatment is continued until a loss in weight of at least 5% is achieved. In the known method, the steam is important because, among other things, the heat treatment can be carried out at normal air pressure and at the same time the temperature can be increased to exceed 200° C., without any risk of the wood catching fire.

In the process of the heat treatment, water steam is evaporated from the moist wood. In connection with our earlier invention, we discovered that the moisture in the wood is not sufficient to protect the wood. As a result, it is necessary to feed water steam continuously into the moist oven.

Our process makes it possible to produce heat-treated timber of good quality. Moreover, the method has been implemented at several industrial plants. By means of the present invention it is possible to improve simultaneously both resistance to decay and dimensional stability, without any reduction in bending strength. On the basis of our tests, a weight loss of 10-14% makes it possible to improve the dimensional stability of the wood by as much as 85%, in which case the weight loss caused by rot fungus is nearly zero and any reduction in the bending strength is kept below 20%.

When the temperature in the heat treatment oven is raised, it is advantageous to control and limit the temperature difference between the inside temperature of the oven and the temperature of the wood; too great a temperature difference may cause the wood to split. The same applies when starting to heat treat wood that is too damp. Our FI Patent Specification No. 104286 describes a method for limiting the formation of internal splits in wood undergoing heat treatment in which the temperature exceeds 90° C. Characteristic of the method is that the moisture content of the inner part of the wood is reduced to less than 10%, after which the temperature of the treatment environment is slowly increased so that the difference between the temperature of the inside of the wood and, correspondingly, its outer surface is at maximum 30° C., typically 10-30° C.

A parallel solution for drying wood is presented in our FI Patent Specification No. 103834.

It is an aim of the present invention to provide a new, alternative method for treating wood at an elevated temperature.

Our invention is based on the idea that when heating a piece of solid wood, such as sawn timber, it is possible to limit in an efficient manner the formation of internal splits—possibly even avoid them altogether—by keeping the difference between the inside temperature of the oven and, correspondingly, the inside temperature of the wood as small as possible, after the moisture content of the piece of wood has reached the fibre saturation point of the wood. A small temperature difference such as this must be maintained when the temperature is further increased, until a moisture content is reached at which the strength properties of the piece of wood are at their best.

According to a preferred embodiment of the present invention, the procedure to be followed above the point at which the fibre saturation point of the wood is such that the difference between the inside temperature of the oven and the inside temperature of the wood is set at a value which is at maximum 10° C., and the heating is carried on while maintaining the said maximum temperature difference of 10° C., until the temperature of the wood has increased to at least 108° C., to prevent formation of internal splits. In practice, this means that at normal air pressure the temperature of the timber (piece of wood) is approximately 102° C. at the lower limit of the range and 108° C. at the upper limit of the range.

More specifically, the method according to the present invention is mainly characterized by what is stated in the characterizing part of claim 1.

Considerable advantages are obtained by means of the invention. Thus, the invention can be used to generate a method for drying unseasoned wood rapidly and efficiently until it is room dry, without the formation of internal splits in the piece of wood which comprises solid wood. At the beginning of the drying stage in the method it is not necessary to take into account the difference between the inside and, correspondingly, the outside temperature of the wood, suggested earlier. Instead, any existing free water can be rapidly removed from the wood, in which case a change of wood colour, which is likely to follow prolonged drying, is also avoided.

Wood which is dried as described above is well suited to heat treatment designed to improve its dimensional stability and resistance to decay. In the heat treatment, the temperature can be increased more rapidly if the wood is first dried carefully in accordance with the present invention to a moisture content level at which the strength of the wood is maximal. The surface of the wood product remains undamaged because water steam is prevented from being suddenly discharged from inside the wood.

Due to the use of steam during the drying stage, the heat can be efficiently introduced into the wood. Another advantage with the use of steam is that the steam plasticizes the surface of the wood (i.e. makes it soft). As a result of this plasticizing, the wood remains undamaged both during the drying stage and during the heat treatment, and, consequently, the method according to the present invention can be used to treat standard measure pieces of wood, without any risk of warping or splitting.

It should also be emphasized that the heat treatment can be carried out at normal air pressure and, at the same time, the temperature can be raised to exceed 200° C., without any risk of the wood catching fire. The reason is that the steam acts as a shielding gas and it can be used to minimize the amount of oxygen present in the oven.

Because the method is operated at normal air pressure, it can be employed industrially: it can be used to treat solid wood, such as sawn timber, logs and poles, because the structure of the heating oven need not be pressure-proof. The oven used in the present invention accommodates standard measure timber, logs and poles, and not only thin veneers and 30 cm long pieces, which were treated in the autoclave according to the reference mentioned above. The costs of the equipment are at least one magnitude smaller than those of the autoclave solutions.

In the following, the present invention will be examined more closely with the aid of a detailed description.

In the first embodiment of the present invention a piece of wood comprising solid wood is treated at an elevated temperature in order to dry it to be room dry (quick-drying method). This moisture level is equivalent to an average moisture content of at maximum 10-15% or 10-13%.

In the second embodiment of the present invention a piece of wood comprising solid wood is treated at a temperature of more than 150° C., most suitably at least 180° C., in order to produce a dimensionally stable and decay resistant product (heat treatment method).

The starting point in both methods is typically unseasoned wood. According to the method, a piece of solid wood, the moisture content of which is at least 30%, is put into an oven, the inside temperature of which can be set at least at approximately 120° C. Typically, the drying, too, is carried out in an oven which is also suitable to be used for heat treatment, in which case the temperature inside the oven can be increased to 180-250° C. In the invention, the purpose is to avoid scorching the wood (i.e. to avoid forming a charred surface layer on the wood surface). Consequently, it is not generally necessary to increase the temperature in the oven above 250° C.

In the method according to the present invention, it is possible to use for instance a device described in FI Patent Publication No. 104285. Generally, the device has an oven, which is surrounded by a jacket and into which the pieces of wood can be introduced. The oven is connected to a steam feeding pipe which can be used to feed water steam into the oven. Inside the oven a fan circulates the air, which is heated using electric resistances to a desired predetermined temperature. Using the device, the pieces of wood can be heated to a desired temperature with a moist, most suitably a saturated steam. The air in the oven is maintained moist by saturated or almost saturated steam.

As a result, the oxygen content in the oven can be efficiently decreased.

The piece of wood is heated in the oven until the inside temperature of that piece of wood has increased to a point at which a pre-specified moisture level is achieved. When the aim is to produce a room dry product, the temperature is typically increased at least to 105° C., especially at least to 108° C., during the drying stage.

The drying stage is carried out in the presence of steam. The reason is that during this stage the surface of the wood should be kept moist for as long as possible. According to a preferred embodiment, saturated water steam is used from the outset in the drying oven. The wet bulb temperature of the steam in the oven compartment can be close to 100° C., most suitably on average approximately 99.8° C.

The steam is fed into the oven especially continuously. We have found that by using a continuous feeding of steam we can reduce the overall volume of steam compared to a two step process whereby a preliminary steaming is first carried out followed by a final steaming at the end of the drying. According to traditional technology, large amounts of steam are blown into the oven initially in order to increase the temperature efficiently, and at the end of the drying to even out the moisture content of the timber again. According to the present invention, continuous steaming makes it possible to keep the volumes of steam small. It is sufficient that steam is introduced into the oven as the drying proceeds.

As a rough estimate of how much steam is used, the amount that is consumed during the entire process of the present invention is equivalent to that consumed during just the initial drying period in a traditional superheated steam drying. Another advantage with using continuous feeding of steam is that a separate final steaming is not necessary at the end of the drying.

The inside temperature of the wood starts to rise from 100° C. immediately after the so- called free water has exited.

In order to prevent internal cracking, the temperatures of the surface part of the wood and the middle part of the wood must be as close to each other as possible when the fibre saturation point of the wood is reached. The thicker the dimension of the timber, the smaller the temperature difference must be (see below). The fibre saturation point of the wood is defined as the level of moisture content at which the water in the wood is adsorbed only onto the walls of the cells, with the free water having already exited from the lumen of the wood fibre

In practice, this means a moisture content of approximately 25-30%, depending on the wood species.

Below is a summary describing an embodiment of the present method, meant for drying of wood. In experimental tests, this embodiment has been found to generate products free of internal splits, up to a dimension of 50 mm and even 75 mm. It should be noted that with thicker dimensions the drying power must be decreased at the expense of the drying time:

The starting temperature of the oven is set approximately at 80-95° C., for instance approximately at 85° C. When the temperature of the wood reaches this value, the temperature of the oven is then increased by 10° C. When the temperature of the inside of the wood reaches 100° C., the temperature of the oven is then set at 120° C. The temperature of the oven is maintained at this temperature until the inside temperature of the wood rises by 1-2° C. In that case, according to the idea of the present invention, the wood has reached its fibre saturation point and the temperature of the oven is then lowered so that the difference between the temperatures of the oven and the wood is at maximum 10° C. When the inside temperature of the wood has increased to 106-108° C., especially to approximately 108° C., the wood is considered to be dried.

After that, the temperature can be gradually lowered if the first stage of the method is used for drying the wood.

The drying time varies from 12 to 36 hours depending on the dimension.

According to the second preferred embodiment, the starting temperature of the oven is immediately set approximately at 120° C., where it is kept until the temperature of the wood rises above 100° C. After that, the temperature in the oven is decreased so that the temperature difference between the oven and the wood is at maximum approximately 10° C.

In both embodiments, the temperature of the oven is decreased—when the fibre saturation point of the wood is reached—from approximately 120° C., first to approximately 110° C., after which it is gradually increased to approximately 115° C., at which temperature it remains until the wood has reached the desired degree of dryness.

Based on what is presented above, the method according to the present invention for oven-drying a solid piece of wood comprising unseasoned sawn timber to a predetermined average level of moisture content, which is typically approximately 10-15%, comprises the following steps:
subjecting the sawn timber to heat treatment in the presence of steam,
feeding steam into the oven most suitably continuously,
boiling out the free water contained in the sawn timber of the wood at a temperature exceeding 100° C., in which case saturated water steam is used in the oven during the drying, and
in order to prevent internal cracking, maintaining the temperature difference between the temperature of the surface of the wood and the middle part of the wood at 10° C. or less when the fibre saturation point of the wood is reached, and maintaining the temperature difference until a predetermined average level of moisture content is reached.

The predetermined average level of the moisture content in question ranges approximately between 5-18%. Generally, the target is approximately 10-15 or 10-13%.

The presented drying method can be used especially to produce room dry wood which is suitable for conventional use, such as production of furniture and instruments. It can be used as starting material for production of heat treated wood, too. In the latter case, the piece of wood is subjected to a heat treatment which is carried out at a temperature of at least 180° C., most suitably 180-250° C.

A heat treatment process such as this can be initiated in order to prevent internal splits occurring, when the wood has been dried to a moisture content of approximately 10-15%. The heat treatment is carried out in a controlled manner by increasing the inside temperature of the oven in stages. The temperature difference between the surface part of the wood and the middle part of the wood is most suitably at maximum 20° C. during the heating. The temperature difference between the surface part of the wood and the inner part of the wood is selected depending, for instance, on the smallest dimension of the wood, according to the table below:

| Smallest dimension | Maximum |
|---|---|
| of the piece of wood | temperature |
| (mm) | difference (° C.) |
| 25 | 20 |
| 50 | 10 |
| 75 | 5 |

During the heat treatment, steam, for instance saturated steam is continuously fed into the oven. In principle, the operating condition is normal air pressure (i.e. “non-pressure” condition) but in practice it is advantageous to maintain the pressure of the steam at a level at which the water in its gas phase will prevent the piece of wood from catching fire. In that case, a slight overpressure is formed in the oven, which prevents oxygen or air from migrating into the oven.

As described in our FI Patent Publication No. 104285, the heat treatment of the piece of wood is continued at a temperature range of approximately 180-250° C., until the loss in weight of the wood is at least 5%, most suitably at least 8%. In order to achieve a good rot-preventing effect, dried sawn pine timber is kept most suitably approximately for 2-8 hours at a temperature of 200-250° C. (see also below). With regard to birch and larch, the same conditions apply, but with spruce a good rot-preventing effect is achieved at a slightly lower temperature, for instance at a temperature of approximately 175-210° C. The method is well suited for treating aspen, too.

Heat treatment of conifer wood takes place especially at a temperature in the range of approximately 190° C. to approximately 230° C., the treatment time being 2-3 hours at this temperature.

After the desired treatment level is reached, the temperature of the oven is decreased, most suitably gradually in order to avoid any structural changes in the wood that may arise from excessive temperature differences.

The temperature of the oven can be gradually lowered by using jet sprayed water. During the lowering of the temperature, the difference in temperature can be 40-50° C. Not until the sawn timber is cooled below 70° C., is the oven door opened.

Organic acids produced by the disintegration of hemicellulose and lignin require that the equipment is constructed of acid-proof material. In order to eliminate emissions, volatile materials must be filtered and neutralized.

To summarise the above: according to a preferred embodiment of the present invention, a method for treating solid pieces of wood comprising unseasoned sawn timber at a temperature of over 180° C. in order to produce a wood product which is dimensionally stable and has a good resistance to decay, comprises the following stages:
the fibre saturation point of the wood and the average moisture content that gives the piece of wood its best strength properties are determined from the piece of wood,
in order to prevent formation of internal splits, the temperature difference between the temperature of the surface part of the wood and the middle part of the wood is maintained at 10° C. or smaller, when the fibre saturation point of the wood is reached,
said temperature difference is maintained until the average moisture content, which corresponds to the best strength properties of the piece of wood, is reached, and
the heat treatment is carried out in an oven in the presence of water steam, at least essentially at normal air pressure, in which case water steam is fed into the oven most suitably continuously.

On the basis of our test results, we have found that it is possible to increase the temperature of the wood very rapidly to 100° C. When the moisture content of the wood reaches the fibre saturation point of the wood, the inside temperature of the wood starts to rise. In that case, the drying power must be decreased to prevent internal splits. As soon as the wood has dried enough (approximately to 13-15%), the temperature can be raised, for instance in suitable steps depending on the dimensions of the timber.

A process according to the present invention is suitable for solid wood, such as sawn timber, logs and poles. In addition, the method can be used for veneers, chips, sawdust, fibres and other cellulose-based products, such as, for instance, packing boxes.

Applications are, among others, the treatment of cladding boards, window frames, outdoor furniture and benches in saunas.

The moisture movement of the wood products is reduced by 50-70% after the treatment according to the present invention. At its best, the decay resistance of the products is improved to the same level as that of pressure treated products, or even higher, without their strength properties being essentially poorer. At the same time, the wood becomes a good painting base.

The strength properties of heartwood, too, can be improved by heat treatment. This is not possible when using pressure treatment. It is possible to strengthen wood species which are difficult to impregnate. Raised permeability of the wood enables other colouring agents to be absorbed by the wood.

It is possible to affect the properties of wood by choosing the temperature at which the wood is held during the heat treatment (the so-called holding time). Consequently, when using a holding time of 2-3 hours at 180° C., the swelling of spruce can be decreased by approximately 40%, correspondingly, at 205° C., by approximately 65%, and, at 230° C., by approximately 80%.

The method can be used to render the properties of the wood, for instance the resistance to decay, equivalent to those of other wood species. The properties of the sapwoods of pine, for example, following a heat treatment of 2-3 hours, are rendered equivalent to those of teak, if the temperature of the heat treatment has been 230° C. Correspondingly, after a heat treatment carried out at 220° C., the result is a product equivalent to oak, and after a treatment at approximately 208° C., a product equivalent to heartwood of pine or Siberian larch.

A natural class III resistance to decay is equivalent to a holding time of 2-3 hours at 190° C. ±3° C., and class II, in turn, equivalent to a holding time of 2-3 hours at 212° C. ±3° C.

### EXAMPLE 1

An oven, the design of which is more closely described in FI Patent Publication 104285, was filled with timber having the dimensions of 50×150 mm.

The temperature of the wood was increased to 100° C. by using steam at 130° C. Following that, the temperature of the oven was set at 110° C. The drying was stopped when the temperature of the wood reached 108° C.

No internal cracks appeared in the pieces of wood.

### EXAMPLE 2

In this test, unseasoned sawn timber was heat treated. The drying stage was similar to that in Example 1. When the temperature of the wood was 108° C., the temperature of the oven was raised in steps of 5° C. During the heat treatment, the temperature was 220° C. and the treatment lasted 2 hours.

No internal cracks appeared in the pieces of wood.

### EXAMPLE 3

The drying stage was carried out in the same way in all test series, that is by feeding hot steam into the oven in order to achieve a desired wood temperature. When the inside temperature of the wood reached 100° C., the temperature of the oven was set at 120° C. The temperature of the oven was maintained at this temperature until the inside temperature of the wood rose by 1-2° C. Then, the temperature of the oven was lowered to 110° C. When the inside temperature of the wood had increased to 108° C., the wood was considered to be dried. After that, the temperature was gradually raised even up to 220° C.

By acting as described above, it was possible to treat the 50 mm thick sawn timber without internal cracks forming.

1. Method of treating a piece of wood comprising solid wood at an elevated temperature, according to which method
a solid piece of wood having a moisture content of at least 30% is placed into an oven, the inside temperature of which can be set at least at approximately 120° C.,
the piece of wood is heated in said oven until the inside temperature of the piece of wood has increased to at least 108° C., and
the heating is carried out in the presence of water steam,
characterized by that
maintaining, during the heating of the piece of wood, the difference between the inside temperature of the oven and the inside temperature of the sawn timber at a value which exceeds 10° C. until the moisture content of the wood has reached the fibre saturation point of the wood, and
then adjusting the difference between the inside temperature of the oven and the inside temperature of the sawn timber at a value which is at maximum 10° C., as well as
continuing heating by maintaining said temperature difference of at maximum 10° C., until the temperature of the wood has increased to at least 108° C., in order to prevent the formation of internal cracks.

2. The method according to claim 1, characterized in that said temperature difference of a maximum of 10° C. is maintained when increasing the temperature of the wood until the moisture content of the wood has decreased to less than 15%, preferably less than 13%.

3. The method according to claim 1, characterized in that a temperature difference of approximately 2-8° C. is maintained between the inside temperature of the oven and, correspondingly, the inside temperature of the wood, when increasing the temperature of the wood from the temperature corresponding to the fibre saturation point of the wood to such a temperature which in the piece of wood corresponds to an average moisture content of at maximum 15%, preferably less than 10%.

4. The method according to Claim 1, characterized in that the solid piece of wood which forms the starting material is introduced into the oven when the temperature of the wood is essentially the same as ambient temperature.

5. The method according to Claim 1, characterized in that the solid piece of wood acting as the initial material is heated until the moisture content level of the wood has reached the fibre saturation point of the wood, in which case the wet bulb temperature of the steam present in the oven is approximately 98-99.9° C.

6. The method according to claim 1, characterized in that the inside temperature of the oven is set at 80-120° C. when the heating of the piece of wood is started.

7. The method according to claim 6, characterized in that the inside temperature of the oven is increased from 80° C. to 120° C. in stages by maintaining the temperature difference between the inside temperature of the oven and the inside temperature of the piece of wood at a maximum of 20° C.

8. The method according to claim 6, characterized in that the inside temperature of the oven is kept at approximately 115-120° C., until the temperature of the piece of wood has increased at maximum to approximately 102° C., after which the oven temperature is decreased to approximately 110° C.

9. The method according to claim 1, characterized in that when drying the piece of wood in order to produce a wood product which is room dry, the heating is stopped when the average moisture content of the wood has decreased to less than 15%, preferably less than 10%.

10. The method according to Claim 1, characterized in that the average moisture content of the wood is decreased to 10-15% or lower, preferably to 10% or lower, after which the piece of wood is subjected to a heat treatment carried out at a temperature of more than 180° C.

11. The method according to claim 10, characterized in that the heat treatment is carried out at 180-250° C.

12. The method according to claim 10, characterized in that the heat treatment is carried out in a controlled way by increasing the inside temperature of the oven in stages so that the temperature difference between the surface part of the wood and the inner part of the wood is at maximum 20° C. during the heating.

13. The method according to claim 12, characterized in that the temperature difference between the surface part of the wood and the inner part of the wood is chosen according to the smallest dimension of the wood, in accordance with the table below:

| Smallest dimension | Maximum |
|---|---|
| of the piece of wood | temperature |
| (mm) | difference (° C.) |
| 25 | 20 |
| 50 | 10 |
| 75 | 5 |

14. The method according to claim 10, characterized in that during the heat treatment the steam pressure in the oven is kept at a high enough level that the water in its gas phase will prevent the piece of wood from catching fire.

15. The method according to claim 10, characterized in that the heating of the piece of wood is carried out at a temperature of more than 180° C., until the loss in weight of the wood is at least 5%, most suitably at least 8%.

16. The method according to claim 1, characterized in that the solid piece of wood comprises sawn timber, the smallest dimension of which is at maximum 75 mm.

17. Method for drying a solid piece of wood comprising unseasoned sawn timber to a predetermined average level of moisture content, according to which method the sawn timber is subjected to heat treatment in the presence of steam, characterized in that
the free water included in the sawn timber is boiled out of the wood at a temperature of more than 100° C., in which case saturated water steam is used in the oven during the drying, and
in order to prevent internal cracks, the temperature difference between the surface part of the wood and the inner part of the wood is maintained at 10° C. or smaller, when the fibre saturation point of the wood is reached, and said temperature difference is maintained until a predetermined average moisture content is achieved.

18. Method for treating a solid piece of wood comprising unseasoned sawn timber at a temperature of more than 180° C. in order to produce a wood product which is dimensionally stable and has a good resistance to decay, in which case the heat treatment is carried out in an oven in the presence of water steam, at least essentially at a normal air pressure, characterized in that
the fibre saturation point of the wood and the average moisture content at which the piece of wood has the best strength properties are determined from the piece of wood,
to prevent the formation of internal cracks, the temperature difference between the surface part of the wood and the inner part of the wood is maintained at 10° C. or smaller, when the fibre saturation point of the wood is reached, and
said temperature difference is maintained until such an average moisture content is reached which corresponds to the best strength properties of the piece of wood.
